(19) United States
(12) Patent Application Publication
(10) Pub. No.: US 2020/0269553 A1
(43) Pub. Date: Aug. 27, 2020

(54) Heavy Layered Mats

(71) Applicant: ExxonMobil Chemical Patents Inc., Baytown, TX (US)

(72) Inventors: Saifudin M. Abubakar, Shanghai (CN); Wei Hu, Shanghai (CN); Ling Ge, Shanghai (CN); Yi Yuan Zhang, Shanghai (CN)

(21) Appl. No.: 16/783,566

(22) Filed: Feb. 6, 2020

Related U.S. Application Data
(60) Provisional application No. 62/809,219, filed on Feb. 22, 2019.

(51) Int. Cl. B32B 27/08; B32B 5/18; B32B 27/06; B32B 27/32; B32B 27/40; B32B 37/06; B32B 37/10; C08L 23/08; C08L 23/12; C08J 5/18; C08J 9/00; C08J 9/228

(52) U.S. Cl. CPC B32B 27/08; C08J 2323/12; B32B 27/065; B32B 27/32; B32B 27/40; B32B 37/06; B32B 37/10; C08L 23/0853; C08L 23/12; C08J 5/18; C08J 9/0085; C08J 9/228; B32B 2266/0278; B32B 2305/022; B32B 2250/02; B32B 2250/246; B32B 2471/04; B32B 2323/046; B32B 2323/10; B32B 2375/00; C08L 2205/025; C08L 2205/03; C08J 2331/04; C08J 2323/06; C08J 2423/06; C08L 2205/035; C08J 2375/04; B32B 5/18

(57) ABSTRACT

A composition suitable for use in forming a heavy layer of a heavy layered mat and include: 5 wt % to 30 wt % a propylene-based elastomer; 5 wt % to 30 wt % low density polyethylene; 0 wt % to 15 wt % linear low density polyethylene; 50 wt % to 90 wt % filler; and 0.1 wt % to 5 wt % processing aid. Optionally, the composition can further include 0.1 wt % to 20 wt % of a stabilizer and/or an antioxidant. Optionally, the composition can further include 0.1 wt % to 10 wt % EVA copolymer, or the composition can have an absence of EVA copolymer.

### CROSS-REFERENCE TO RELATED APPLICATIONS

This application claims priority to U.S. Ser. No. 62/809,219, filed Feb. 22, 2019, herein incorporated by reference.

### BACKGROUND

The present disclosure relates to heavy layered mats used, for example, as sound barriers in vehicles.

In automotive technology, heavy layer moldings or heavy layered mats are employed especially for sound insulation in the passenger compartment against engine and driving noises. Moreover, heavy layered mats are used for sound-deadening (body noise damping) of vibrating bodywork.

Heavy layered mats include a sound insulating heavy layer and a foam layer and/or textile fleece layer. The heavy layer is made of ethylenevinylacetate (EVA) copolymer and/or ethylene-propylene-diene monomer (EPDM) rubber and contains a filler like calcium carbonate or barium sulfate. The heavy layer has a relatively high weight. Often, it has a weight per area from 2 kg/m² to 4 kg/m², occasionally even a weight per area between 4 kg/m² and 8 kg/m².

Typically, the heavy layer is molded into a desired shape before the foam and/or textile fleece layers are applied. However, heavy layers produced with EPDM rubber can change thickness and have a resulting uneven thickness during the preheating step and crack or break during the thermoforming step associated with applying the additional layer(s). Such thickness changes are believed to result from EPDM having an insufficient melt strength. The inclusion of EVA copolymer increases the melt strength, but EVA copolymer causes the heavy layer to have a lingering vinegar odor. Newer heavy layer formulations have included linear low-density polyethylene (LLDPE) to increase melt strength. However, cracking and breaking of the heavy layer is still observed when producing heavy layered mats with such compositions.

### SUMMARY OF THE INVENTION

The present disclosure relates to heavy layered mats used, for example, as sound barriers in vehicles.

An embodiment of the present invention is a composition comprising: 5 wt % to 30 wt % a propylene-based elastomer; 5 wt % to 30 wt % low density polyethylene; 0 wt % to 15 wt % linear low density polyethylene; 50 wt % to 90 wt % filler; and 0.1 wt % to 5 wt % processing aid. Optionally, the composition can further comprise 0.1 wt % to 20 wt % of a stabilizer and/or an antioxidant. Optionally, the composition can further comprise 0.1 wt % to 10 wt % EVA copolymer, or the composition is substantially free of EVA copolymer.

Another embodiment is a heavy layered mat comprising: a heavy layer composed of the foregoing composition; and a polyurethane layer on a face of the heavy mat layer.

Yet another embodiment is a heavy layered mat comprising: a heavy layer composed of foregoing composition; a polyurethane foam layer on a face of the heavy layer; and a plurality of fibers on the polyurethane foam layer such that the polyurethane foam layer is between the heavy layer and the plurality of fibers.

Another embodiment is a heavy layered mat comprising: a heavy layer composed of foregoing composition; a polyurethane foam layer on a face of the heavy layer; and a multilayer binder film on the polyurethane foam layer such that the polyurethane foam layer is between the heavy layer and the multilayer binder film, wherein the multilayer binder film comprises a polar layer and a nonpolar layer.

Another example embodiment is a method comprising: thermoforming a polymer sheet having a face and a back surface with a mold to produce a molded polymer sheet, the polymer sheet comprising: the foregoing composition; and injecting a polyurethane foam into the mold such that the polyurethane foam is on the back surface of the molded polymer sheet.

### BRIEF DESCRIPTION OF THE DRAWINGS

The following figures are included to illustrate certain aspects of the embodiments, and should not be viewed as exclusive embodiments. The subject matter disclosed is capable of considerable modifications, alterations, combinations, and equivalents in form and function, as will occur to those skilled in the art and having the benefit of this disclosure.

FIG. 1 is an outline of the steps of an example method 100 for forming heavy layers and heavy layered mats.

FIG. 2 is the extensional viscosity measurements of various samples at 0.01 s⁻¹ strain rate.

FIG. 3 is the extensional viscosity measurements of various samples at 0.1 s⁻¹ strain rate.

FIG. 4 is the extensional viscosity measurements of various samples at 1 s⁻¹ strain rate.

FIG. 5 is the extensional viscosity measurements of various samples at 10 s⁻¹ strain rate.

FIG. 6 is the maximum elongation viscosity for various samples at various strain rates.

FIG. 7 is the tensile strength of various injection molded samples.

FIG. 8 is the flex modulus of various injection molded samples.

FIG. 9 is Izod text measurements at room temperature and low temperature for various samples.

FIG. 10 is the extensional viscosity measurements of various samples at 0.01 s⁻¹ strain rate.

FIG. 11 is the extensional viscosity measurements of various samples at 0.1 s⁻¹ strain rate.

FIG. 12 is the extensional viscosity measurements of various samples at 1 s⁻¹ strain rate.

FIG. 13 is the extensional viscosity measurements of various samples at 10 s⁻¹ strain rate.

FIG. 14 is the maximum elongation viscosity for various samples at various strain rates.

FIG. 15 is a photograph of a crack in the molded comparative heavy layer.

FIG. 16 is a photograph of the molded inventive have layer, which has no cracks.

### DETAILED DESCRIPTION

The present disclosure relates to heavy layered mats used, for example, as sound barriers in vehicles. More specifically, the present invention includes heavy layer compositions with sufficiently increased melt strength to be processed by conventional methods to produce heavy layered mats. Further, the heavy layer compositions described herein preferably are substantially free of EVA copolymer and, therefore, have no vinegar odor associated therewith.

A heavy layer composition of the present invention can comprise 5 wt % to 30 wt % a propylene-based elastomer; 5 wt % to 30 wt % low density polyethylene (LDPE) having a melt index of 0.5 g/10 min to 1.5 g/10 min (ASTM D1238-13, 2.16 kg, 190° C.); 0 wt % to 15 wt % LLDPE; 50 wt % to 90 wt % filler; and 0.1 wt % to 5 wt % processing aid. Optionally, the composition can further comprise 0.1 wt % to 20 wt % of a stabilizer and/or an antioxidant. Optionally, the composition can further comprise 0.1 wt % to 10 wt % EVA copolymer, or the composition is substantially free of EVA copolymer. Without being limited by theory, it is believed that replacement of some or all of the LLDPE with LDPE increases the melt strength of the formulation and produces a heavy layer that is more effective in producing high quality heavy layered mats.

### Definitions

As used herein, “wt %” means weight percent, “mol %” means mole percent, “vol %” means volume percent, and all molecular weights, e.g., Mw, Mn, Mz, are in units of g/mol, unless otherwise noted. Furthermore, all molecular weights are Mw unless otherwise noted.

The term “polymer” refers to any carbon-containing compound having repeat units from one or more different monomers and encompasses homopolymers, copolymers, terpolymers, and the like. A “copolymer” is a polymer having two or more monomer units that are different from each other. A “terpolymer” is a polymer having three monomer units that are different from each other. Accordingly, the definition of copolymer, as used herein, includes terpolymers and the like.

As used herein, when a polymer is referred to as comprising a monomer, the monomer is present in the polymer in the polymerized form of the monomer or in the derivative form of the monomer. The term “derived units” as used herein, refers to the polymerized form of the monomer from which the polymer was derived. For example, when a copolymer is said to have an “ethylene” content of 35 wt % to 55 wt %, it is understood that the monomer unit in the copolymer is derived from ethylene in the polymerization reaction and said derived units are present at 35 wt % to 55 wt %, based upon the weight of the copolymer. Furthermore, polyethylene comprises ethylene-derived units. Further, a terpolymer of propylene/ethylene/butene comprises propylene-derived units, ethylene-derived units and butane-derived units.

As used herein, “elastomer” or “elastomeric composition” refers to any polymer or composition of polymers (such as blends of polymers) consistent with the ASTM D1566-11 definition. Elastomer includes mixed blends of polymers such as melt mixing and/or reactor blends of polymers. The terms may be used interchangeably with the term “rubber(s).”

As used herein, the terms “low density polyethylene” and “LDPE” refers to a polyethylene homopolymer or copolymer having a density of from 0.915 g/cm³ to 0.935 g/cm³, a melt flow index (ASTM D1238-13, 2.16 kg, 190° C.) of 0.2 g/10 min to 10 g/10 min, and a melt flow ratio (ASTM D1238-13, 21.6 kg, 190° C. divided by ASTM D1238-13, 2.16 kg, 190° C.) of greater than 40.

As used herein, the terms “linear low density polyethylene” and “LLDPE” refers to a polyethylene homopolymer or copolymer having a density of from 0.900 g/cm³ to 0.955 g/cm³, a melt flow index (ASTM D1238-13, 2.16 kg, 190° C.) of 0.1 g/10 min to 30 g/10 min, and a melt flow ratio (ASTM D1238-13, 21.6 kg, 190° C. divided by ASTM D1238-13, 2.16 kg, 190° C.) of 15 to 40.

As used herein, a composition that is “substantially free” of a substance means that the composition includes no amount of the substance or such a small amount of the substance that the substance does not materially affect the basic and novel characteristic(s) of the composition. In particular, with respect to EVA, a composition that is substantially free of EVA may include no EVA (0 wt %), or it may include a small amount of EVA that does not result in a vinegar odor or impact the melt strength of the composition.

### Propylene-Based Elastomers

The propylene-based elastomers may be a copolymer of propylene-derived units and units derived from at least one of ethylene or a C₄ to C₁₀ alpha-olefin. The propylene-based elastomer may contain at least 60 wt % propylene-derived units based on the weight of the propylene-based elastomer. The propylene-based elastomer may have limited crystallinity due to adjacent isotactic propylene units and a melting point as described herein. The crystallinity and the melting point of the propylene-based elastomer can be reduced compared to highly isotactic polypropylene by the introduction of errors in the insertion of propylene. The propylene-based elastomer is generally devoid of any substantial intermolecular heterogeneity in tacticity and comonomer composition, and also generally devoid of any substantial heterogeneity in intramolecular composition distribution.

The amount of propylene-derived units present in the propylene-based elastomer may be present in an amount from at least 60 wt %, at least 65 wt %, at least 70 wt %, at least 75 wt %, at least 80 wt %, at least 84 wt %, at least 85 wt %, at least 88 wt %, at least 90 wt %, at least 92 wt %, at least 94 wt %, at least 96 wt % or at least 98 wt % of the propylene-based elastomer. Additionally or alternatively, the amount of propylene-derived units present in the propylene-based elastomer may be present in an amount of, at most 98 wt %, at most 96 wt %, at most 94 wt %, at most 92 wt %, at most 90 wt %, at most 88 wt %, at most abut 85 wt %, at most 84 wt % or at most 80 wt % of the propylene-based elastomer. Ranges expressly disclosed include combinations of any of the above-enumerated values like 60 wt % to 98 wt %, 70 wt % to 98 wt %, 80 wt % to 98 wt %, 85 wt % to 98 wt %, 90 wt % to 98 wt %, 70 wt % to 96 wt %, 75 wt % to 96 wt %, 80 wt % to 96 wt %, 85 wt % to 96 wt %, 90 wt % to 96 wt %.

The units, or comonomers, derived from at least one of ethylene or a C₄ to C₁₀ alpha-olefin may be present in an amount of 1 wt % to 35 wt %, or 2 wt % to 35 wt %, or 5 wt % to 35 wt %, or 7 wt % to 32 wt %, or 8 wt % to 25 wt %, or 10 wt % to 25 wt %, or 12 wt % to 20 wt %, or 8 wt % to 20 wt %, or 8 wt % to 18 wt %, or 5 wt % to 20 wt %, or 5 wt % to 15 wt %, or 2 wt % to 10 wt %, or 2 wt % to 6.0 wt %, based on the weight of the propylene-based elastomer.

In preferred embodiments, the comonomer is ethylene, 1-hexene, or 1-octene. In some embodiments, the propylene-based elastomer comprises ethylene-derived units or consists essentially of units derived from propylene and ethylene, i.e., the propylene-based elastomer does not contain any other comonomer in an amount other than that typically present as impurities in the ethylene and/or propylene feedstreams used during polymerization, or in an amount that would materially affect the 1% secant flexural modulus and/or melt mass-flow rate of the propylene-based elastomer, or any other comonomer intentionally added to the polymerization process. In such embodiments, the propylene-based elastomer may comprise 2 wt % to 25 wt %, or 5 wt % to 25 wt %, or 10 wt % to 25 wt %, or 6 wt % to 22 wt %, or 12 wt % to 20 wt %, or 7 wt % to 20 wt %, or 5 wt % to 20 wt %, or 5 wt % to 15 wt %, or 8 wt % to 17 wt %, or 9 wt % to 16 wt %, or 2 wt % to 10 wt % or 2 wt % to 6.0 wt %, ethylene-derived units based on the weight of the propylene-based elastomer.

The propylene-based elastomer may comprise more than one comonomer. Preferred embodiments of a propylene-based elastomer having more than one comonomer include propylene-ethylene-octene, propylene-ethylene-hexene, and propylene-ethylene-butene polymers. In embodiments where more than one comonomer derived from at least one of ethylene or a C₄ to C₁₀ alpha-olefin is present, the amount of one comonomer may be less than 5 wt % of the propylene-based elastomer, but the combined amount of comonomers of the propylene-based elastomer is 5 wt % or greater of the total propylene-based elastomer.

In some embodiments, the propylene-based elastomer may further comprise a diene. The optional diene may be any hydrocarbon structure having at least two unsaturated bonds wherein at least one of the unsaturated bonds is readily incorporated into a polymer. For example, the optional diene may be selected from straight chain acyclic olefins, such as 1,4-hexadiene and 1,6-octadiene; branched chain acyclic olefins, such as 5-methyl-1,4-hexadiene, 3,7-dimethyl-1,6-octadiene, and 3,7-dimethyl-1,7-octadiene; single ring alicyclic olefins, such as 1,4-cyclohexadiene, 1,5-cyclooctadiene, and 1,7-cyclododecadiene; multi-ring alicyclic fused and bridged ring olefins, such as tetrahydroindene, norbornadiene, methyl-tetrahydroindene, dicyclopentadiene, bicyclo-(2.2.1)-hepta-2,5-diene, norbornadiene, alkenyl norbornenes, alkylidene norbornenes, e.g., ethylidiene norbornene (“ENB”), cycloalkenyl norbornenes, and cycloalkyliene norbornenes (such as 5-methylene-2-norbornene, 5-ethylidene-2-norbornene, 5-propenyl-2-norbornene, 5-isopropylidene-2-norbornene, 5-(4-cyclopentenyl)-2-norbornene, 5-cyclohexylidene-2-norbornene, 5-vinyl-2-norbornene); and cycloalkenyl-substituted alkenes, such as vinyl cyclohexene, allyl cyclohexene, vinyl cyclooctene, 4-vinyl cyclohexene, allyl cyclodecene, vinyl cyclododecene, and tetracyclo (A-11,12)-5,8-dodecene. The amount of diene-derived units present in the propylene-based elastomer may range from an upper limit of 15 wt %, 10 wt %, 7 wt %, 5 wt %, 4.5 wt %, 3 wt %, 2.5 wt %, or 1.5 wt %, to a lower limit of 0%, 0.1 wt %, 0.2 wt %, 0.3 wt %, 0.5 wt %, or 1 wt %, based on the total weight of the propylene-based elastomer. In some embodiments, the propylene-based elastomer does not contain any diene-derived units.

The propylene-based elastomer may have a triad tacticity of three propylene units, as measured by ¹³C NMR, of at least 75%, at least 80%, at least 82%, at least 85%, or at least 90%. Preferably, the propylene-based elastomer has a triad tacticity of 50% to 99%, 60% to 99%, 75% to 99%, or 80% to 99%. In some embodiments, the propylene-based elastomer may have a triad tacticity of 60% to 97%.

The propylene-based elastomer may have a heat of fusion (“ΔH_{f}”), as determined by DSC as described herein, of 75 J/g or less, 70 J/g or less, 50 J/g or less, or 45 J/g or less, or 35 J/g or less. The propylene-based elastomer may have a lower limit ΔH_{f} of 0.5 J/g, 1 J/g, or 5 J/g. For example, the ΔH_{f} value may be anywhere from 1.0 J/g, 1.5 J/g, 3.0 J/g, 4.0 J/g, 6.0 J/g, or 7.0 J/g, to 30 J/g, 35 J/g, 40 J/g, 50 J/g, 60 J/g, 70 J/g, or 75 J/g.

The propylene-based elastomer may have a percent crystallinity, as determined according to the DSC procedure described herein, of 2% to 65%, 0.5% to 40%, 1% to 30%, or 5% to 35%, of the crystallinity of isotactic polypropylene. The thermal energy for the highest order of propylene (i.e., 100% crystallinity) is estimated at 189 J/g. In some embodiments, the copolymer has crystallinity less than 40%, or in the range of 0.25% to 25%, or 0.5% to 22%, of isotactic polypropylene. Embodiments of the propylene-based elastomer may have a tacticity index m/r from a lower limit of 4 or 6 to an upper limit of 8 or 10 or 12. In some embodiments, the propylene-based elastomer has an isotacticity index greater than 0%, or within the range having an upper limit of 50% or 25%, and a lower limit of 3% or 10%.

The propylene-based elastomer may have a 1% secant flexural modulus, as measured according to ASTM D790-17, of at least 5.0 MPa, at least 10 MPa, at least 20 MPa, at least 30 MPa, at least 40 MPa, at least 50 MPa, at least 60 MPa, at least 70 MPa, at least 80 MPa, at least 90 MPa, at least 100 MPa, at least 125 MPa, at least 150 MPa, at least 175 MPa, at least 200 MPa, at least 225 MPa, at least 250 MPa, at least 275 MPa, at least 300 MPa, at least 325 MPa, at least 350 MPa, at least 375 MPa, at least 400 MPa, at least 425 MPa, at least 450 MPa, at least 475 MPa, or 500 MPa. Additionally or alternatively, the propylene-based elastomer may have a 1% secant flexural modulus, as measured according to ASTM D790-17, of at most 500 MPa, at most 475 MPa, at most 450 MPa, at most 425 MPa, at most 400 MPa, at most 375 MPa, at most 350 MPa, at most 325 MPa, at most 300 MPa, at most 275 MPa, at most 250 MPa, at most 225 MPa, at most 200 MPa, at most 175 MPa, at most 150 MPa, at most 125 MPa, at most 100 MPa, at most 90 MPa, at most 80 MPa, at most 70 MPa, at most 60 MPa, at most 50 MPa, at most 40 MPa, at most 30 MPa, at most 20 MPa, at most 10 MPa, or 5.0 MPa. Ranges expressly disclosed include combinations of any of the above-enumerated values like 5.0 MPa to 500 MPa, 5.0 to 250 MPa, 5.0 MPa to 100 MPa, 5.0 MPa to 50 MPa, 5 MPa to 20 MPa, 20 MPa to 500 MPa, 20 MPa to 250 MPa, 20 MPa to 100 MPa, 20 MPa to 50 MPa, 40 MPa to 500 MPa, 40 MPa to 250 MPa, 40 to 100 MPa, 40 MPa to 70 MPa, 40 MPa to 60 MPa, 50 MPa to 500 MPa, 50 MPa to 250 MPa, 50 MPa to 100 MPa, 100 MPa to 500 MPa, 100 MPa to 250 MPa, 200 MPa to 500 MPa, 200 MPa to 450 MPa, 200 MPa to 400 MPa, 200 MPa to 350 MPa, 200 MPa to 300 MPa, 300 MPa to 500 MPa, 300 MPa to 450 MPa, 300 MPa to 400 MPa, 300 MPa to 350 MPa, 350 MPa to 500 MPa, 350 MPa to 450 MPa, 350 MPa to 400 MPa.

The propylene-based elastomer may have a melt mass-flow rate, as measured according to ASTM D1238-13, 2.16 kg at 230° C., of at least 5 g/10 min, at least 15 g/10 min, at least 50 g/10 min, at least 100 g/10 min, at least 1,000 g/10 min, at least 2,500 g/10 min, at least 5,000 g/10 min, at least 7,500 g/10 min, at least 10,000 g/10 min, at least 12,500 g/10 min, at least 15,000 g/10 min, at least 17,500 g/10 min, at least 20,000 g/10 min, at least 22,500 g/10 min, at least 25,000 g/10 min, at least 27,500 g/10 min or 30,000 g/10 min. Additionally or alternatively, the propylene-based elastomer may have a melt mass-flow rate, as measured according to ASTM D1238-13, 2.16 kg at 230° C., of at most 30,000 g/10 min, at most 27,500 g/10 min, at most 25,000 g/10 min, at most 22,500 g/10 min, at most 20,000 g/10 min, at most 17,500 g/10 min, at most 15,000 g/10 min, at most 12,500 g/10 min, at most 10,000 g/10 min, at most 7,500 g/10 min, at most 5,000 g/10 min, at most 2,500 g/10 min, at most 1,000 g/10 min, at most 100 g/10 min, at most 50 g/10 min, at most 15 g/10 min, or 5 g/10 min Ranges expressly disclosed include combinations of any of the above-enumerated values like 5 g/10 min to 30,000 g/10 min, 5 g/10 min to 20,000 g/10 min, 5 g/10 min to 10,000 g/10 min, 5 g/10 min to 1,000 g/10 min, 5 g/10 min to 100 g/10 min, 5 g/10 min to 50 g/10 min, 5 g/10 min to 15 g/10 min, 1,000 g/10 min to 30,000 g/10 min, 1,000 g/10 min to 20,000 g/10 min, 1,000 g/10 min to 10,000 g/10 min, 1,000 g/10 min to 5,000 g/10 min, 10,000 g/10 min to 30,000 g/10 min, 10,000 g/10 min to 20,000 g/10 min, 10,000 g/10 min to 15,000 g/10 min, 20,000 g/10 min to 30,000 g/10 min, 20,000 g/10 min to 27,500 g/10 min, 22,500 g/10 min to 30,000 g/10 min, 22,500 g/10 min to 27,500,000 g/10 min, 22,500 g/10 min to 25,000 g/10 min.

The propylene-based elastomer may have a melting point temperature (Tₘ) of 105° C. or less, 100° C. or less, 90° C. or less, 80° C. or less, or 70° C. or less. In some embodiments, the propylene-based elastomer has a Tₘ of 25° C. to 105° C., 60° C. to 105° C., 70° C. to 105° C., or 90° C. to 105° C.

The DSC procedures for determining Tₘ and ΔH_{f} of the propylene-based elastomer include the following. The polymer is pressed at a temperature of from 200° C. to 230° C. in a heated press, and the resulting polymer sheet is hung, under ambient conditions (of 20° C.-23.5° C.), in the air to cool. A 6 to 10 mg sample of the polymer sheet is removed with a punch die. This 6 to 10 mg sample is annealed at room temperature (22° C.) for 80 hours to 100 hours. At the end of this period, the sample is placed in a DSC (Perkin Elmer Pyris One Thermal Analysis System) and cooled at a rate of 10° C./min to −30° C. to −50° C. and held for 10 minutes at −50° C. The sample is heated at 10° C./min to attain a final temperature of 200° C. The sample is kept at 200° C. for 5 minutes. Then a second cool-heat cycle is performed, using the same conditions described above. Events from both cycles, “first melt” and “second melt”, respectively, are recorded. The thermal output is recorded as the area under the melting peak of the sample, which typically occurs between 0° C. and 200° C. It is measured in Joules and is a measure of the ΔH_{f} of the polymer. Reference to melting point temperature and ΔH_{f} herein refers to the first melt.

The propylene-based elastomer may have a density of 0.850 g/cm³ to 0.920 g/cm³, or 0.860 g/cm³ to 0.890 g/cm³, at room temperature as measured per ASTM D1505-18.

The propylene-based elastomer may have an elongation at break, as measured per ASTM D638-14, of at least 200%, at least 500%, at least 1000%, at least 1500%, at least 2000% or at least 3000%.

The propylene-based elastomer may have a weight average molecular weight (Mw) of 5,000 g/mole to 5,000,000 g/mole, 10,000 g/mole to 1,000,000 g/mole, 20,000 g/mole to 750,000 g/mole, 30,000 g/mole to 400,000 g/mole.

The propylene-based elastomer may have a number average molecular weight (Mn) of 2,500 g/mole to 250,000 g/mole, 10,000 g/mole to 250,000 g/mole, or 25,000 g/mole to 200,000 g/mole.

The propylene-based elastomer may have a z-average molecular weight (Mz) of 10,000 g/mole to 7,000,000 g/mole, 80,000 g/mole to 700,000 g/mole, or 100,000 g/mole to 500,000 g/mole.

The propylene-based elastomer may have a molecular weight distribution (“MWD”) of 1.5 to 20, or 1.5 to 15, preferably 1.5 to 5, and more preferably 1.8 to 3, and most preferably 1.8 to 2.5.

Molecular weight (weight-average molecular weight, Mw, number-average molecular weight, Mn, and molecular weight distribution, Mw/Mn or MWD) are determined using a High Temperature Size Exclusion Chromatograph (SEC) (either from Waters Corporation or Polymer Laboratories), equipped with a differential refractive index detector (DRI), an online light scattering (LS) detector, and a viscometer. Three Polymer Laboratories PLgel 10 mm Mixed-B columns were used. The nominal flow rate was 0.5 cm³/min, and the nominal injection volume was 300 μL. The various transfer lines, columns and differential refractometer (the DRI detector) were contained in an oven maintained at 145° C. Polystyrene was used to calibrate the instrument. Solvent for the SEC experiment is prepared by dissolving 6 g of butylated hydroxy toluene as an antioxidant in 4 L of Aldrich reagent grade 1,2,4 trichlorobenzene (TCB). The TCB mixture is then filtered through a 0.7 μm glass pre-filter and subsequently through a 0.1 μm Teflon filter. The TCB is then degassed with an online degasser before entering the SEC. Polymer solutions are prepared by placing the dry polymer in a glass container, adding the desired amount of TCB, then heating the mixture at 160° C. with continuous agitation for hours. All quantities are measured gravimetrically. The TCB densities used to express the polymer concentration in mass/volume units are 1.463 g/mL at room temperature and 1.324 g/mL at 135° C. The injection concentration ranges from 1.0 mg/mL to 2.0 mg/mL, with lower concentrations being used for higher molecular weight samples. Prior to running each sample, the DRI detector and the injector are purged. Flow rate in the apparatus is then increased to 0.5 mL/min, and the DRI was allowed to stabilize for 8-9 hours before injecting the first sample. The LS laser is turned on 1 hour to 1.5 hours before running samples. The concentration, c, at each point in the chromatogram is calculated from the baseline-subtracted DRI signal, IDRI, using the following equation:

c=K_{DRI}I_{DRI}/(dn/dc)

where K_{DRI} is a constant determined by calibrating the DRI, and do/dc is the same as described below for the LS analysis. Units on parameters throughout this description of the SEC method are such that concentration is expressed in g/cm³, molecular weight is expressed in kg/mol, and intrinsic viscosity is expressed in dL/g.

The light scattering detector used is a Wyatt Technology High Temperature mini-DAWN. The polymer molecular weight, M, at each point in the chromatogram is determined by analyzing the LS output using the Zimm model for static light scattering (M. B. Huglin, Light Scattering from Polymer Solutions, Academic Press, 1971):

$$[ \frac{{K}_{o} c}{Δ R ( θ , c )} ] = [ \frac{1}{M P ( θ )} ] + 2 {A}_{2} c$$

where ΔR(θ) is the measured excess Rayleigh scattering intensity at scattering angle θ, c is the polymer concentration determined from the DRI analysis, A₂ is the second virial coefficient, P(θ) is the form factor for a monodisperse random coil (described in the above reference), and Kₒ is the optical constant for the system:

$${K}_{o} = \frac{4 {π}^{2} {{n}^{2} ( dn \text{/} d c )}^{2}}{{λ}^{4} {N}_{A}}$$

where N_{A} is the Avogadro's number, and dn/dc is the refractive index increment for the system. The refractive index, n=1.500 for TCB at 135° C. and λ=690 nm. In addition, A2=0.0015 and dn/dc=0.104 for ethylene polymers, whereas A2=0.0006 and dn/dc=0.104 for propylene polymers.

The molecular weight averages are usually defined by considering the discontinuous nature of the distribution in which the macromolecules exist in discrete fractions i containing Nᵢ molecules of molecular weight Mᵢ. The weight-average molecular weight, M_{w}, is defined as the sum of the products of the molecular weight Mᵢ of each fraction multiplied by its weight fraction wᵢ:

$${M}_{w} ≡ Σ {w}_{i} {M}_{i} = ( \frac{Σ {N}_{i} {M}_{i}^{2}}{Σ {N}_{i} {M}_{i}} )$$

since the weight fraction wᵢ is defined as the weight of molecules of molecular weight Mᵢ divided by the total weight of all the molecules present:

$${w}_{i} = \frac{{N}_{i} {M}_{i}}{Σ {N}_{i} {M}_{i}}$$

The number-average molecular weight, Mₙ, is defined as the sum of the products of the molecular weight Mᵢ of each fraction multiplied by its mole fraction xᵢ:

$${M}_{n} ≡ Σ {x}_{i} {M}_{i} = ( \frac{Σ {N}_{i} {M}_{i}}{Σ {N}_{i}} )$$

since the mole fraction xᵢ is defined as Nᵢ divided by the total number of molecules:

$${x}_{i} = \frac{{N}_{i}}{Σ {N}_{i}}$$

In the SEC, a high temperature Viscotek Corporation viscometer is used, which has four capillaries arranged in a Wheatstone Bridge configuration with two pressure transducers. One transducer measures the total pressure drop across the detector, and the other, positioned between the two sides of the bridge, measures a differential pressure. The specific viscosity, ηₛ, for the solution flowing through the viscometer is calculated from their outputs. The intrinsic viscosity, [η], at each point in the chromatogram is calculated from the following equation:

ηₛ=c[η]+0.3(c[η])²

where c was determined from the DRI output.

The branching index (g′, also referred to as g′(vis)) is calculated using the output of the SEC-DRI-LS-VIS method as follows. The average intrinsic viscosity, |η|_{avg}, of the sample is calculated by:

$${η}_{a v g} = \frac{Σ {{c}_{i} [ η ]}_{i}}{Σ {c}_{i}}$$

where the summations are over the chromatographic slices, i, between the integration limits.

Various propylene-based elastomers having any combination of the above-described properties are contemplated herein.

The propylene-based elastomer may comprise copolymers prepared according to the procedures described in WO 02/36651, U.S. Pat. No. 6,992,158, and/or WO 00/01745, the contents of which are incorporated herein by reference. Preferred methods for producing the propylene-based elastomer may be found in U.S. Pat. Nos. 7,232,871 and 6,881,800, the contents of which are incorporated herein by reference. The invention is not limited by any particular polymerization method for preparing the propylene-based elastomer, and the polymerization processes are not limited by any particular type of reaction vessel.

Suitable propylene-based elastomers may be available commercially under the trade names VISTAMAXX™ (available from ExxonMobil Chemical Company) (e.g., VISTAMAXX™ 3000, VISTAMAXX™ 3588FL, VISTAMAXX™ 6102, VISTAMAXX™ 8880), VERSIFY™ (available from The Dow Chemical Company), certain grades of TAFMER™ XM or NOTIO™ (available from Mitsui Company), and certain grades of SOFTEL™ (available from Basell Polyolefins). The particular grade(s) of commercially available propylene-based elastomer suitable for use in the invention can be readily determined using methods commonly known in the art.

A heavy layer composition of the present invention can comprise one or more propylene-based elastomers at a total concentration of 5 wt % to 30 wt %, or 7 wt % to 20 wt %, or 10 wt % to 18 wt %, or 12 wt % to 15 wt %, based on the weight of the heavy layer composition.

### Low Density Polyethylene

LDPEs have a density of 0.915 g/cm³ to 0.935 g/cm³, or 0.920 g/cm³ to 0.930 g/cm³.

LDPEs have a melt flow index (ASTM D1238-13, 2.16 kg, 190° C.) of 0.2 g/10 min to 10 g/10 min, or 0.5 g/10 min to 7 g/10 min, or 1 g/10 min to 5 g/10 min.

LDPEs have a melt flow ratio (ASTM D1238-13, 21.6 kg, 190° C. divided by ASTM D1238-13, 2.16 kg, 190° C.) of greater than 40, or 40 to 300, or 60 to 250, or 75 to 200.

LDPEs can be polyethylene homopolymers. Alternatively, LDPEs can be ethylene copolymers with a C₃ to C₂₀ alpha-olefin. Comonomer examples include propylene, 1-butene, 3-methyl-1-butene, 3,3-dimethyl-1-butene, 1-pentene, 1-pentene with one or more methyl, ethyl, or propyl substituents, 1-hexene, 1-hexene with one or more methyl, ethyl, or propyl substituents, 1-heptene, 1-heptene with one or more methyl, ethyl, or propyl substituents, 1-octene, 1-octene with one or more methyl, ethyl, or propyl substituents, 1-nonene, 1-nonene with one or more methyl, ethyl, or propyl substituents, ethyl, methyl, or dimethyl-substituted 1-decene, 1-dodecene, and styrene. Exemplary combinations of ethylene and comonomers include: ethylene 1-butene, ethylene 1-pentene, ethylene 4-methyl-1-pentene, ethylene 1-hexene, ethylene 1-octene, ethylene decene, ethylene dodecene, ethylene 1-butene 1-hexene, ethylene 1-butene 1-pentene, ethylene 1-butene 4-methyl-1-pentene, ethylene 1-butene 1-octene, ethylene 1-hexene 1-pentene, ethylene 1-hexene 4-methyl-1-pentene, ethylene 1-hexene 1-octene, ethylene 1-hexene decene, ethylene 1-hexene dodecene, ethylene propylene 1-octene, ethylene 1-octene 1-butene, ethylene 1-octene 1-pentene, ethylene 1-octene 4-methyl-1-pentene, ethylene 1-octene 1-hexene, ethylene 1-octene decene, ethylene 1-octene dodecene, and combinations thereof. It should be appreciated that the foregoing list of comonomers and comonomer combinations are merely exemplary and are not intended to be limiting. Preferably, the comonomer is 1-butene, 1-hexene, or 1-octene. Most preferably, the comonomer is 1-hexene.

In a copolymer, ethylene-derived unit can comprise 65 wt % to 99.9 wt %, or 70 wt % to 99 wt %, or 85 wt % to 95 wt % of the LDPE, and the comonomer can comprise 0.1 wt % to 35 wt %, or 5 wt % to 15 wt % of the LDPE.

LDPE that are useful in this invention include those commercially available under the trade designation EXXONMOBIL™ LDPE by ExxonMobil Chemical Company including, but not limited to, those available under the grade names: LD250, LD259, LD258, LD251, LD252, LD650 LD653, LD200.48, LD201.48 and LD202.48.

The LDPEs described herein are not limited by any particular method of preparation and may be formed using any process known in the art. For example, the LDPE may be formed by high pressure autoclave or tubular reactor processes.

A heavy layer composition of the present invention can comprise one or more LDPEs at a total concentration of 5 wt % to 30 wt %, or 10 wt % to 20 wt %, or 5 wt % to 18 wt %, or 7 wt % to 15 wt %, based on the weight of the heavy layer composition.

### Linear Low Density Polyethylene

LLDPEs have a density of 0.900 g/cm³ to 0.955 g/cm³, or 0.910 g/cm³ to 0.950 g/cm³, or 0.920 g/cm³ to 0.945 g/cm³.

LLDPEs have a melt flow index (ASTM D1238-13, 2.16 kg, 190° C.) of 0.2 g/10 min to 30 g/10 min, or 0.5 g/10 min to 25 g/10 min, or 1 g/10 min to 20 g/10 min.

LLDPEs have a melt flow ratio (ASTM D1238-13, 21.6 kg, 190° C. divided by ASTM D1238-13, 2.16 kg, 190° C.) of 15 to 40, or 18 to 35, or 20 to 25.

LLDPEs can be polyethylene homopolymers. Alternatively, LLDPEs can be ethylene copolymers with a C₃ to C₂₀ alpha-olefin. Comonomer examples include propylene, 1-butene, 3-methyl-1-butene, 3,3-dimethyl-1-butene, 1-pentene, 1-pentene with one or more methyl, ethyl, or propyl substituents, 1-hexene, 1-hexene with one or more methyl, ethyl, or propyl substituents, 1-heptene, 1-heptene with one or more methyl, ethyl, or propyl substituents, 1-octene, 1-octene with one or more methyl, ethyl, or propyl substituents, 1-nonene, 1-nonene with one or more methyl, ethyl, or propyl substituents, ethyl, methyl, or dimethyl-substituted 1-decene, 1-dodecene, and styrene. Exemplary combinations of ethylene and comonomers include: ethylene 1-butene, ethylene 1-pentene, ethylene 4-methyl-1-pentene, ethylene 1-hexene, ethylene 1-octene, ethylene decene, ethylene dodecene, ethylene 1-butene 1-hexene, ethylene 1-butene 1-pentene, ethylene 1-butene 4-methyl-1-pentene, ethylene 1-butene 1-octene, ethylene 1-hexene 1-pentene, ethylene 1-hexene 4-methyl-1-pentene, ethylene 1-hexene 1-octene, ethylene 1-hexene decene, ethylene 1-hexene dodecene, ethylene propylene 1-octene, ethylene 1-octene 1-butene, ethylene 1-octene 1-pentene, ethylene 1-octene 4-methyl-1-pentene, ethylene 1-octene 1-hexene, ethylene 1-octene decene, ethylene 1-octene dodecene, and combinations thereof. It should be appreciated that the foregoing list of comonomers and comonomer combinations are merely exemplary and are not intended to be limiting. Preferably, the comonomer is 1-butene, 1-hexene, or 1-octene. Most preferably, the comonomer is 1-hexene.

In a copolymer, ethylene-derived unit can comprise 65 wt % to 99.9 wt %, or 70 wt % to 99 wt %, or 85 wt % to 95 wt % of the LLDPE, and the comonomer can comprise 0.1 wt % to 35 wt %, or 5 wt % to 15 wt % of the LLDPE.

LLDPE that are useful in this invention include those commercially available under the trade designation EXCEED™ XP (available from ExxonMobil Chemical Company), EXXONMOBIL™ LLDPE (available from ExxonMobil Chemical Company), and EXXONMOBIL™ NTX LLDPE (available from ExxonMobil Chemical Company).

The LLDPEs described herein are not limited by any particular method of preparation and may be formed using any process known in the art. For example, the LLDPE may be formed by high pressure autoclave or tubular reactor processes.

A heavy layer composition of the present invention can comprise one or more LDDPEs (when present) at a total concentration of 0.1 wt % to 15 wt %, or 1 wt % to 10 wt %, or 1 wt % to 5 wt %, or 0.1 wt % to 2 wt %, based on the weight of the heavy layer composition. A heavy layer composition of the present invention can have an absence of LLDPE.

### Filler

Examples of fillers can include, but are not limited to, carbon black, fly ash, graphite, cellulose, starch, flour, wood flour, polymeric fibers like polyester-based, polyamide-based materials, calcium carbonate, aluminum trihydrate, talc, glass fibers, marble dust, cement dust, clay, feldspar, silica or glass, fumed silica, alumina, magnesium oxide, antimony oxide, zinc oxide, barium sulfate, calcium sulfate, aluminum silicate, calcium silicate, titanium dioxide, titanates, clay, nanoclay, organo-modified clay or nanoclay, glass microspheres, chalk, and the like, and combinations thereof.

A heavy layer composition of the present invention can comprise one or more fillers at a total concentration of 50 wt % to 90 wt %, or 60 wt % to 85 wt %, or 65 wt % to 80 wt %, or 75 wt % to 85 wt %, or 70 wt % to 75 wt %, based on the weight of the heavy layer composition.

### Processing Aids

Examples of processing aids include, but are not limited to, paraffinic oil, naphthenic oil, polyalphaolefin (PAO) fluid, waxes, fatty acid salts, such as calcium stearate or zinc stearate, alcohols, including glycols, glycol ethers, alcohol ether, polyesters, and the like, and combinations thereof.

A heavy layer composition of the present invention can comprise one or more processing aids at a total concentration of 0.1 wt % to 5 wt %, or 1 wt % to 4 wt %, or 3 wt % to 5 wt %, or 0.1 wt % to 3 wt %, based on the weight of the heavy layer composition.

### Other Additives

A heavy layer composition of the present invention can comprise other additives. Examples of other additives include, but are not limited to, fire retardants, antioxidants, flow improvers, coloring agents, reinforcements, adhesive additives, and the like, and combinations thereof.

The heavy layer composition may further contain an adhesive additive that can facilitate the bonding of the extruded composition with the primary layer and the tufted carpet fibers. Useful bonding agent comprises maleic anhydride functionalized EVA. When employed, the adhesive additives can be present in an amount of up to 10 wt %, or 0.1 wt % to 10 wt %, or 1 wt % to 8 wt %, or 1 wt % to 5 wt %, based on the weight of the heavy layer composition.

The heavy layer composition may contain a heat stabilizer and/or antioxidant. Hindered amine stabilizers, e.g., CHIMASSORB™ available from Ciba Specialty Chemicals, are exemplary heat and light stabilizers. Further, hindered phenols can be used as an antioxidant. Some suitable hindered phenols include those available from Ciba Specialty Chemicals of under the trade name IRGANOX™. When employed, the antioxidant and/or the stabilizer, may each be present in an amount of up to 20 wt %, or 0.1 wt % to 20 wt %, or 0.5 wt % to 15 wt %, or 1 wt % to 10 wt %, based on the weight of the heavy layer composition.

### Making the Heavy Layers and Heavy Layered Mats

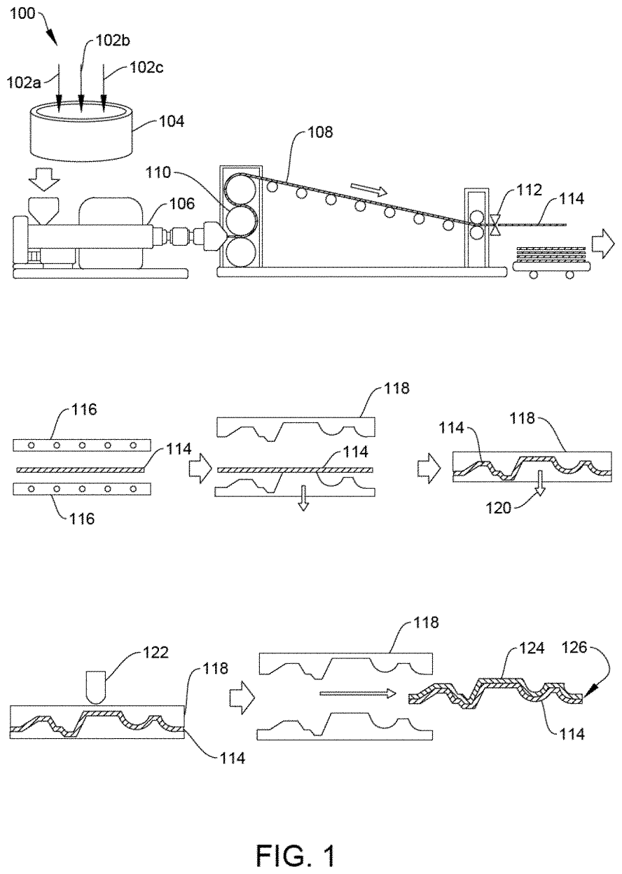

FIG. 1 is an outline of the steps of an example method 100 for forming heavy layers and heavy layered mats. First, the heavy layer compositions according to this disclosure may be compounded by any known method. For example, the compounding may be carried out by mixing the components 102a, 102b, 102c, etc. of the heavy layer composition to a continuous mixer 104 such as a Brabender mixer, a mill, or an internal mixer such as Banbury mixer. The compounding may also be conducted in a continuous process such as a twin screw extruder 106. Optionally, a portion of the components of the heavy layer compositions can be blended before blending with the remaining components.

After heating and blending the components in the mixer 104 into a heavy layer melt, the heavy layer melt can be extruded via the extruder 106 into a heavy layer sheet 108 having a thickness of 0.1 mm to 5 mm, or 0.5 mm to 4 mm, or 1 mm to 3 mm, or 3 mm to 5 mm During extrusion, rollers 110 can be used to make the heavy layer sheet a desired thickness. A cutter 112 then cuts the heavy layer sheet 108 into individual heavy layers 114.

The heavy layers 114 can then be molded. First, a heater 116 is used to preheat the heavy layer 114. Then, the preheated heavy layer 114 is put into a mold 118 where vacuum 120 and heat are applied to thermoform the heavy layer 114. While in the mold 118, a small amount of space is available between the molded heavy layer 114 and the top of the mold, which allows space for polyurethane foam 122 to be injected into the mold and form polyurethane foam layer 124 on one side of the heavy layer 114. The result is a heavy layered mat 126 having two layers: a heavy layer 114 and a polyurethane foam layer 124. Optionally, additional steps can be performed as known to those skilled in the art to apply carpet or other fabric to the polyurethane foam layer 124.

The polyurethane foam layer 124 can have a thickness of 0.1 mm to 5 mm, or 0.5 mm to 4 mm, or 1 mm to 3 mm, or 3 mm to 5 mm.

An exemplary heavy layered mat comprises a heavy layer composed of a heavy layer composition described herein; and a polyurethane layer on a face of the heavy layer.

Another exemplary heavy layered mat comprises a heavy layer composed of a heavy layer composition described herein; a polyurethane layer on a face of the heavy layer; and a plurality of fibers on the polyurethane foam layer such that the polyurethane foam layer is between the heavy layer and the plurality of fibers.

Yet another exemplary heavy layered mat comprises a heavy layer composed of a heavy layer composition described herein; a polyurethane foam layer on a face of the heavy layer; and a multilayer binder film on the polyurethane foam layer such that the polyurethane foam layer is between the heavy layer and the multilayer binder film, wherein the multilayer binder film comprises a polar layer and a nonpolar layer.

Advantageously, the heavy layer compositions of the present invention have an increased melt strength, which enables the heavy layers to be preheated and thermoformed while maintaining their integrity and thickness. Further, the heavy layer compositions described herein preferably are substantially free of EVA copolymer and, therefore, have no vinegar odor associated therewith.

### EXAMPLE EMBODIMENTS

A first embodiment of the present invention is a composition comprising: 5 wt % to 30 wt % a propylene-based elastomer; 5 wt % to 30 wt % low density polyethylene; 0 wt % to 15 wt % linear low density polyethylene; 50 wt % to 90 wt % filler; and 0.1 wt % to 5 wt % processing aid. Optionally, the compositions may include one or more of the following: Element 1: wherein the composition has an absence of linear low density polyethylene; Element 2: wherein the composition has an absence of ethylene vinyl acetate copolymer; Element 3: wherein the low density polyethylene is a homopolymer of polyethylene; Element 4: wherein the low density polyethylene has 65 wt % to 99.9 wt % ethylene-derived units, 0.1 wt % to 35 wt % units derived from at least one of a C₃-C₁₂ alpha-olefin; Element 5: wherein the linear low density polyethylene is a homopolymer of polyethylene; Element 6: wherein the linear low density polyethylene has 65 wt % to 99.9 wt % ethylene-derived units, 0.1 wt % to 35 wt % units derived from at least one of a C₃-C₁₂ alpha-olefin; Element 7: wherein the composition further comprises 0.1 wt % to 20 wt % of a stabilizer and/or an antioxidant; and Element 8: wherein the composition further comprises ethylene vinyl acetate copolymer at 0.1 wt % to 10 wt %. Examples of combinations include, but are not limited to, Elements 1 and 2 in combination and optionally in further combination with one of Elements 3 and 4; Elements 7 and 8 in combination and optionally in further combination with one of Elements 3 and 4; one of Elements 3 and 4 in combination with Element 1; one of Elements 3 and 4 in combination with Element 2; one of Elements 3 and 4 in combination with Element 7; one of Elements 3 and 4 in combination with Element 8; one of Elements 3 and 4 in combination with one of Elements 5 or 6 and optionally in further combination with Element 2; and one of Elements 5 or 6 in combination with Element 2.

Another embodiment is a heavy layered mat comprising: a heavy layer composed of the first example composition (optionally including one or more of the foregoing optional elements); and a polyurethane layer on a face of the heavy mat layer.

Yet another embodiment is a heavy layered mat comprising: a heavy layer composed of the first example composition (optionally including one or more of the foregoing optional elements); a polyurethane foam layer on a face of the heavy layer; and a plurality of fibers on the polyurethane foam layer such that the polyurethane foam layer is between the heavy layer and the plurality of fibers.

Yet another embodiment is a heavy layered mat comprising: a heavy layer composed of the first example composition (optionally including one or more of the foregoing optional elements); a polyurethane foam layer on a face of the heavy layer; and a multilayer binder film on the polyurethane foam layer such that the polyurethane foam layer is between the heavy layer and the multilayer binder film, wherein the multilayer binder film comprises a polar layer and a nonpolar layer.

In the three foregoing examples of heavy layered mats, the heavy layer can optionally have a thickness of 0.1 mm to 5 mm and/or the polyurethane foam layer can optionally have a thickness of 0.1 mm to 5 mm.

Another example embodiment is a method comprising: thermoforming a polymer sheet having a face and a back surface with a mold to produce a molded polymer sheet, the polymer sheet comprising: the first example composition (optionally including one or more of the foregoing optional elements); and injecting a polyurethane foam into the mold such that the polyurethane foam is on the back surface of the molded polymer sheet.

Optionally, the example method may include one or more of: the method further comprising: attaching a plurality of fibers to the polyurethane foam via hot compression; attaching a multilayer binder film to the polyurethane foam via hot compression, wherein the multilayer binder film comprises a polar layer and a nonpolar layer; the heavy layer can optionally have a thickness of 0.1 mm to 5 mm; and/or the polyurethane foam layer can optionally have a thickness of 0.1 mm to 5 mm.

Unless otherwise indicated, all numbers expressing quantities of ingredients, properties such as molecular weight, reaction conditions, and so forth used in the present specification and associated claims are to be understood as being modified in all instances by the term “about.” Accordingly, unless indicated to the contrary, the numerical parameters set forth in the following specification and attached claims are approximations that may vary depending upon the desired properties sought to be obtained by the embodiments of the present invention. At the very least, and not as an attempt to limit the application of the doctrine of equivalents to the scope of the claim, each numerical parameter should at least be construed in light of the number of reported significant digits and by applying ordinary rounding techniques.

One or more illustrative embodiments incorporating the invention embodiments disclosed herein are presented herein. Not all features of a physical implementation are described or shown in this application for the sake of clarity. It is understood that in the development of a physical embodiment incorporating the embodiments of the present invention, numerous implementation-specific decisions must be made to achieve the developer's goals, such as compliance with system-related, business-related, government-related and other constraints, which vary by implementation and from time to time. While a developer's efforts might be time-consuming, such efforts would be, nevertheless, a routine undertaking for those of ordinary skill in the art and having benefit of this disclosure.

While compositions and methods are described herein in terms of “comprising” various components or steps, the compositions and methods can also “consist essentially of” or “consist of” the various components and steps.

To facilitate a better understanding of the embodiments of the present invention, the following examples of preferred or representative embodiments are given. In no way should the following examples be read to limit, or to define, the scope of the invention.

### Examples

Example 1. Blends were prepared according to the formulations in Table 1.

TABLE 1

| | | | | VISTAMAXX ™ Grades | | | |
|---|---|---|---|---|---|---|---|
| Sam- | EVA | LLDPE | LDPE | 3000 | 3588 | 6102 | 6202 |
| ple | (wt %) | (wt %) | (wt %) | (wt %) | (wt %) | (wt %) | (wt %) |
| 1 | 67 | 33 | 0 | 0 | 0 | 0 | 0 |
| 2 | 0 | 33 | 0 | 67 | 0 | 0 | 0 |
| 3 | 0 | 33 | 0 | 0 | 0 | 0 | 67 |
| 4 | 0 | 0 | 33 | 67 | 0 | 0 | 0 |
| 5 | 0 | 0 | 33 | 0 | 67 | 0 | 0 |
| 6 | 0 | 0 | 33 | 0 | 0 | 67 | 0 |
| 7 | 0 | 0 | 33 | 0 | 0 | 0 | 67 |

The extensional viscosity of each sample was measured. The extensional rheology property of polymer plays an important role in the processing technological process and the ultimate performance. All samples are prepared first to a sheet by compression molding. The extensional viscosity test was conducted by STC-EM-RHE-05.00 test method at 200° C. on ARES EFV instrument, a nitrogen atmosphere was used to avoid oxidative degradation. All samples were test under a series of strain rates: 0.01 s⁻¹, 0.1 s⁻¹, 1 s⁻¹, 10 s⁻¹. Sample 1, which is a market reference, exhibited strain hardening, which indicates a good melt strength. Samples 2 and 3, which are comparative sample where no LDPE is included, did not exhibit strain hardening, which indicates a poor melt strength. Samples 4-7, which are inventive samples, exhibited strain hardening, which indicates a good melt strength.

Example 2. Samples having a weight ratio of 40:60 of a polymer blend to filler (CaCO₃) were prepared. The polymer blends used are provided in Table 2. The properties of the individual polymers in the blends are provided in Table 3. The thermal properties of the samples (i.e., polymer blend having filler therein) are provided in Table 4.

TABLE 2

| | | LLDPE | LDPE | LDPE | |
|---|---|---|---|---|---|
| | VISTAMAXX ™ | 7042 | 165BW | 150AT | INFUSE ™ |
| Sample | 6102 (wt %) | (wt %) | (wt %) | (wt %) | 9102* (wt %) |
| 8 | 67 | 33 | 0 | 0 | 0 |
| 9 | 67 | 0 | 33 | 0 | 0 |
| 10 | 67 | 0 | 0 | 33 | 0 |
| 11 | 50 | 0 | 33 | 0 | 17 |

*Available from Dow Chemical

TABLE 3

| | MFR (190° C./ | Density | Elongation | | |
|---|---|---|---|---|---|
| Polymer | 2.16 kg) | (g/cm³) | to Break | Tensile | |
| VISTAMAXX ™ 6102 | 1.4 g/10 min | 0.862 | >800% | >7.58 | MPa |
| LDPE 150AT | 0.75 g/10 min | 0.923 | 310% | 28 | MPa |
| LDPE 165BW | 0.33 g/10 min | 0.922 | 280% | 13 | MPa |
| LLDPE 7042 | 1.5~2.5 g/10 min | 0.915-0.921 | >500% | >8 | MPa |
| INFUSE 9102 | 1 g/10 min | 0.877 | 480% | 6.6 | MPa |

TABLE 4

| Sample | Tc | Tm | Tg | ΔHc |
|---|---|---|---|---|
| 40:60 wt % Sample | 110.4 | 123.4 | −30.5 | 9.5 |
| 8 to CaCO₃ | | | | |
| 40:60 wt % Sample | 96.1 | 110.1 | −30.2 | 16.3 |
| 9 to CaCO₃ | | | | |
| 40:60 wt % Sample | 96.7 | 109.8 | −31.1 | 17.6 |
| 10 to CaCO₃ | | | | |
| 40:60 wt % Sample | 97.9 | 109.5 | −31.4 | 10.9 |
| 11 to CaCO₃ | | | | |

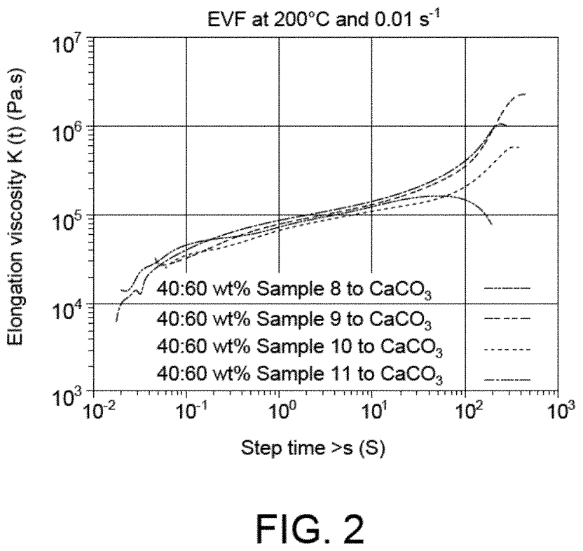

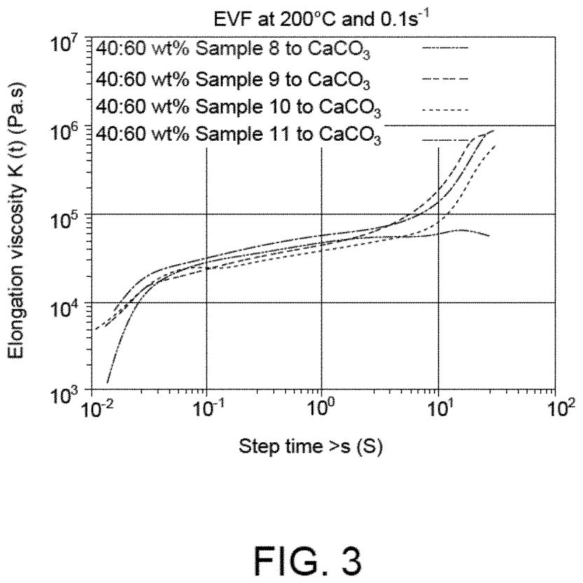

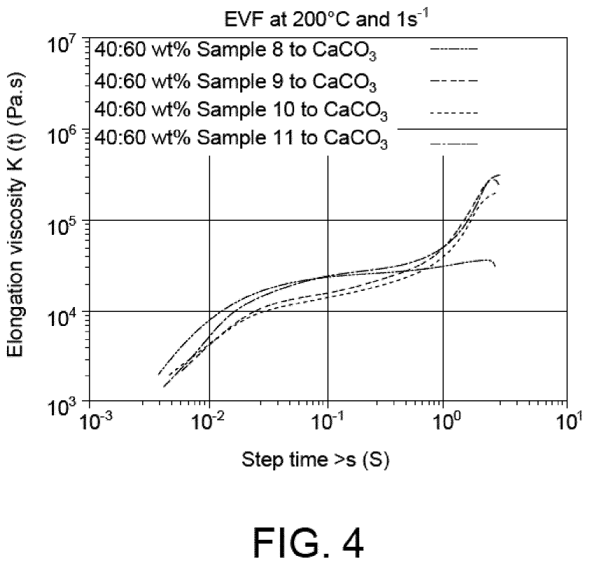

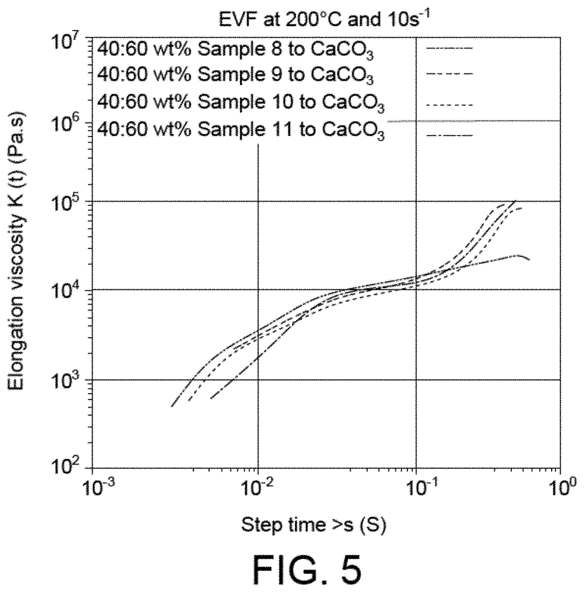

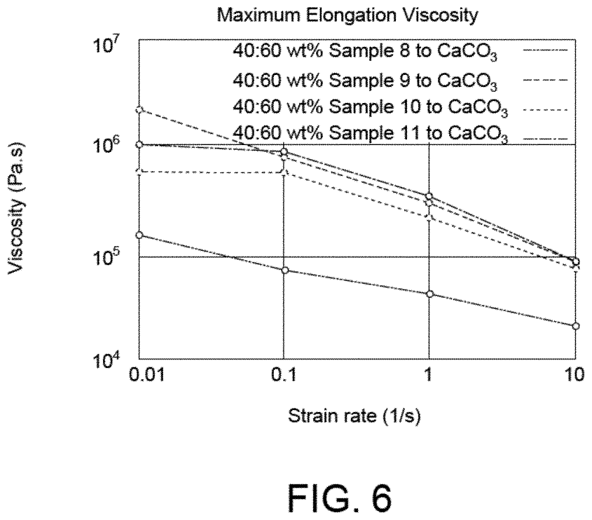

The extensional viscosity for each of the samples 8-11 was measured as described in Example 1. FIGS. 2-5 provide the extensional viscosity measurements at 0.01 s⁻¹, 0.1 s⁻¹, 1 s⁻¹, and 10 s⁻¹, respectively. FIG. 6 is the maximum elongation viscosity for each sample at the various strain rates. Samples 9-11, which each include LDPE but no LLDPE, each achieve higher elongation viscosity than sample 8, which includes LLDPE but no LDPE.

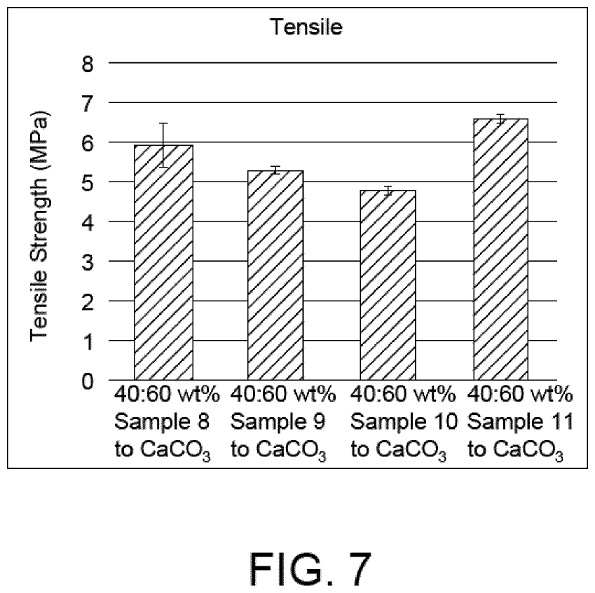

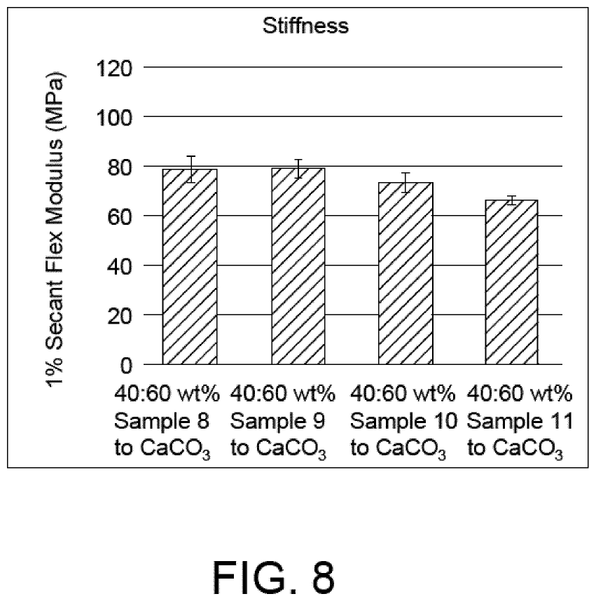

The tensile strength for samples 8-11 is provided in FIG. 7. Tensile bars were prepared by injection molding. The flex modulus for samples 8-11 is provided in FIG. 8. Flex modulus sample bars were prepared by injection molding. The tensile strength and stiffness of the samples cannot be explained by the presence of LDPE or LLDPE.

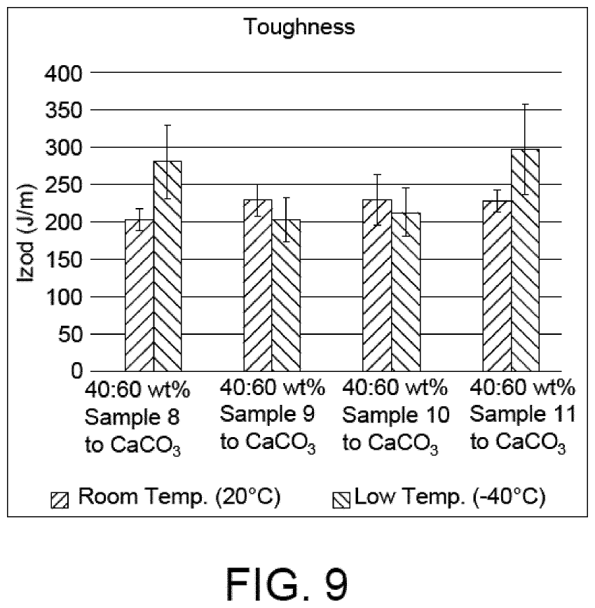

Both room temperature (20° C.) and low temperature (−40° C.) Izod tests were conducted on samples 8-11; the results are shown in FIG. 9. For Samples 9 and 10, which include VISTAMAXX™ 6102 and LDPE, the impact resistance in cold conditions is worse than the impact resistance at room temperature. Further, no breakage was observed for all samples, indicating that the VISTAMAXX™ 6102-based formulations have good impact resistance.

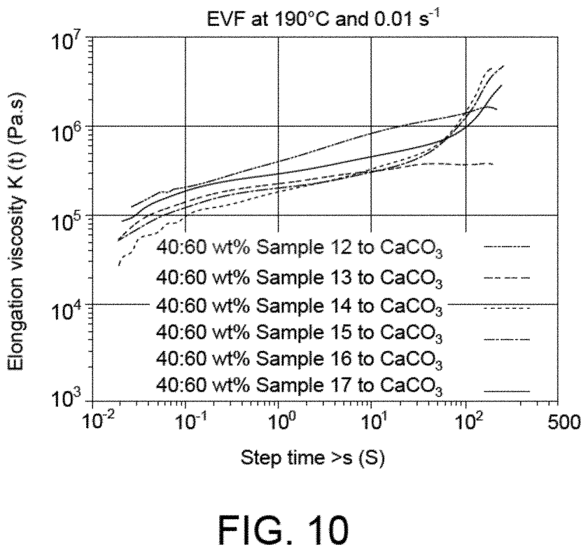

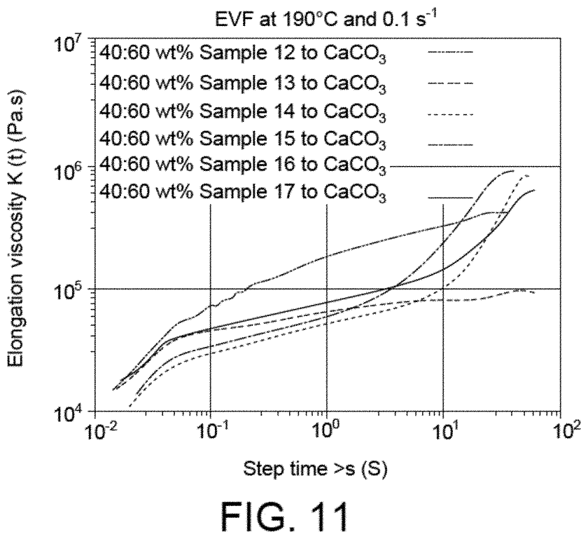

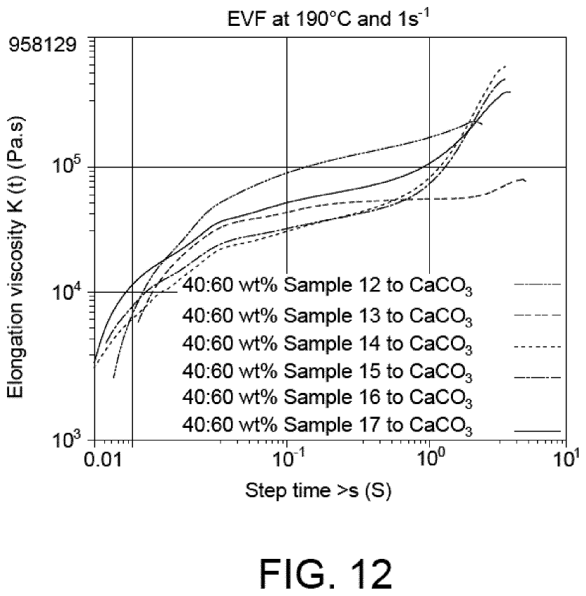

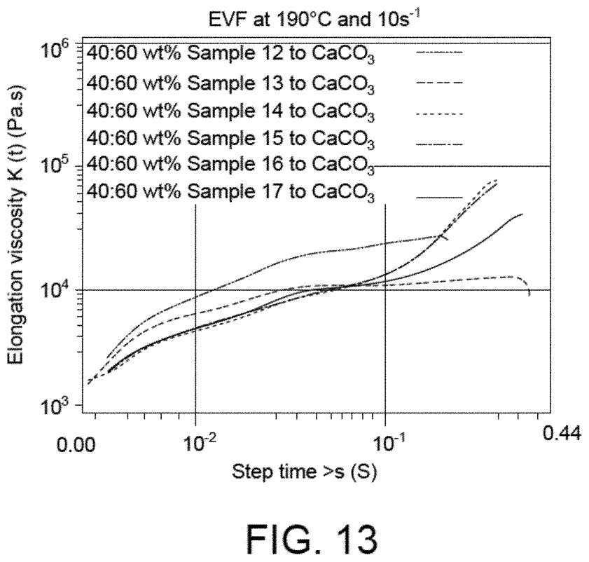

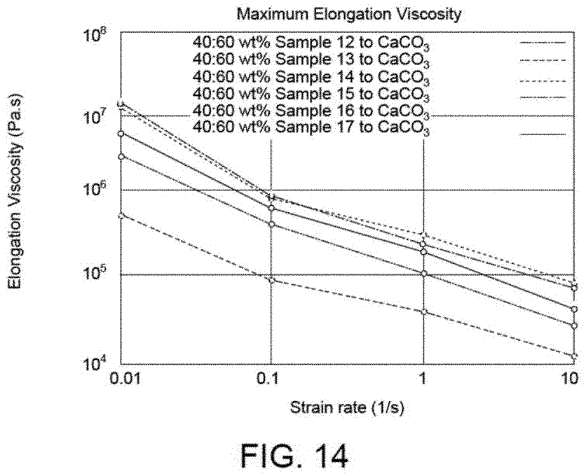

Example 3. Samples 12-17 were prepared according to Table 5. The extensional viscosity for Samples 12-17 were measured as described in Example 1, except that measurements were taken at 190° C. FIGS. 10-13 provide the extensional viscosity measurements for Samples 12-17 at 0.01 s⁻¹, 0.1 s⁻¹, 1 s⁻¹, and 10 s⁻¹, respectively. FIG. 14 shows the maximum elongation viscosity for each of Samples 12-17 at the various strain rates. Samples 14-17, which include LDPE but no LLDPE, have better elongation viscosity than both EVA-based Sample 12 and LLDPE-based Sample 13, which indicates that adding LDPE at high filler loading formulation is correlated with improved melt strength.

TABLE 5

| | VISTAMAXX ™ | EVA | LLDPE | LDPE | | |
|---|---|---|---|---|---|---|
| Sample | 6102 (wt %) | 5110J | 7042 | 1810 | TPE* | CaCO₃ |
| 12 | 0 | 15 | 10 | 0 | 0 | 75 |
| 13 | 15 | 0 | 10 | 0 | 0 | 75 |
| 14 | 15 | 0 | 0 | 15 | 0 | 70 |
| 15 | 15 | 0 | 0 | 10 | 0 | 75 |
| 16 | 10 | 0 | 0 | 15 | 0 | 75 |
| 17 | 10 | 0 | 0 | 10 | 5 | 75 |

*thermoplastic elastomer

Example 4. A comparative heavy layer was prepared with a heavy layer composition comprising 10 wt % to 15 wt % VISTAMAXX™, 10 wt % to 15 wt % LLDPE, 65 wt % to 75 wt % calcium carbonate and barium sulfate, and 2 wt % to 5 wt % processing oil. An inventive heavy layer was prepared with a heavy layer composition comprising 10 wt % to 15 wt % VISTAMAXX™, 10 wt % to 15 wt % LDPE, 65 wt % to 75 wt % calcium carbonate and barium sulfate, and 2 wt % to 5 wt % processing oil.

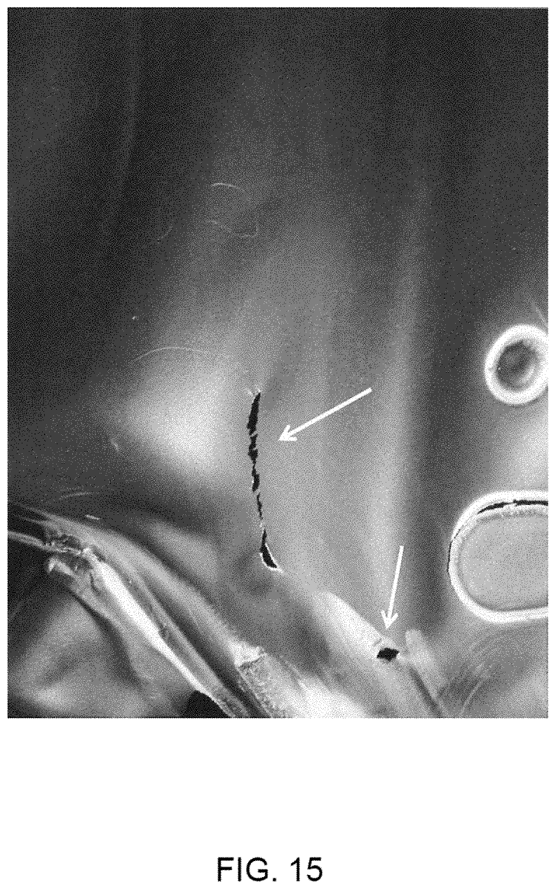

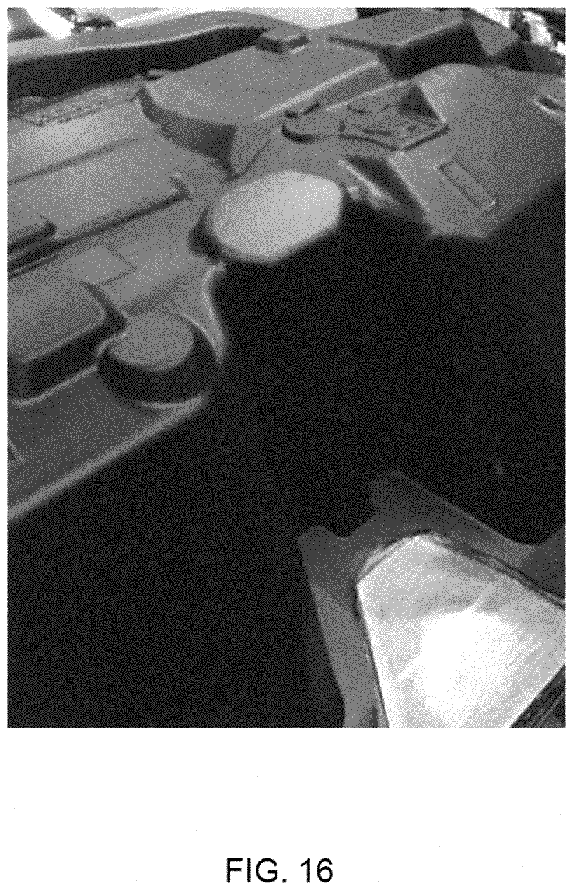

These heavy layers were thermoformed into molded heavy layers. FIG. 15 is a photograph of a crack in the molded comparative heavy layer. FIG. 16 is a photograph of the molded inventive heavy layer, which has no cracks.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered, combined, or modified and all such variations are considered within the scope and spirit of the present invention. The invention illustratively disclosed herein suitably may be practiced in the absence of any element that is not specifically disclosed herein and/or any optional element disclosed herein. While compositions and methods are described in terms of “comprising,” “containing,” or “including” various components or steps, the compositions and methods can also “consist essentially of” or “consist of” the various components and steps. All numbers and ranges disclosed above may vary by some amount. Whenever a numerical range with a lower limit and an upper limit is disclosed, any number and any included range falling within the range is specifically disclosed. In particular, every range of values (of the form, “from a to b,” or, equivalently, “from approximately a to b,” or, equivalently, “from approximately a-b”) disclosed herein is to be understood to set forth every number and range encompassed within the broader range of values. Also, the terms in the claims have their plain, ordinary meaning unless otherwise explicitly and clearly defined by the patentee. Moreover, the indefinite articles “a” or “an,” as used in the claims, are defined herein to mean one or more than one of the element that it introduces.

The invention claimed is:

1. A composition comprising:
5 wt % to 30 wt % a propylene-based elastomer;
5 wt % to 30 wt % low density polyethylene;
0 wt % to 15 wt % linear low density polyethylene;
50 wt % to 90 wt % filler; and
0.1 wt % to 5 wt % processing aid.

2. The composition of claim 1, wherein the composition further comprises 0.1 wt % to 20 wt % of a stabilizer and/or an antioxidant.

3. The composition of claim 1, wherein the composition has an absence of linear low density polyethylene.

4. The composition of claim 1, wherein the composition has an absence of ethylene vinyl acetate copolymer.

5. The composition of claim 1, wherein the composition further comprises ethylene vinyl acetate copolymer at 0.1 wt % to 10 wt %.

6. The composition of claim 1, wherein the low density polyethylene is a homopolymer of polyethylene.

7. The composition of claim 1, wherein the low density polyethylene has 65 wt % to 99.9 wt % ethylene-derived units, 0.1 wt % to 35 wt % units derived from at least one of a C₃-C₁₂ alpha-olefin.

8. The composition of claim 1, wherein the linear low density polyethylene is a homopolymer of polyethylene.

9. The composition of claim 1, wherein the linear low density polyethylene has 65 wt % to 99.9 wt % ethylene-derived units, 0.1 wt % to 35 wt % units derived from at least one of a C₃-C₁₂ alpha-olefin.

10. A heavy layered mat comprising:
a heavy layer composed of the composition of claim 1; and
a polyurethane layer on a face of the heavy layer.

11. A heavy layered mat comprising:
a heavy layer composed of the composition of claim 1;
a polyurethane foam layer on a face of the heavy layer; and
a layer on the polyurethane foam layer such that the polyurethane foam layer is between the heavy layer and the layer.

12. The heavy layered mat of claim 11, wherein the layer comprises a plurality of fibers.

13. The heavy layered mat of claim 11, wherein the layer comprises a multilayer binder film that comprises a polar layer and a nonpolar layer.

14. The heavy layered mat of claim 11, wherein the heavy layer has a thickness of 0.1 mm to 5 mm.

15. The heavy layered mat of claim 11, wherein the polyurethane foam layer has a thickness of 0.1 mm to 5 mm.

16. A method comprising:
thermoforming a polymer sheet having a face and a back surface with a mold to produce a molded polymer sheet, the polymer sheet comprising:
5 wt % to 30 wt % a propylene-based elastomer;
5 wt % to 30 wt % low density polyethylene;
0 wt % to 15 wt % linear low density polyethylene;
50 wt % to 90 wt % filler; and
0.1 wt % to 5 wt % processing aid; and
injecting a polyurethane foam into the mold such that the polyurethane foam is on the back surface of the molded polymer sheet.

17. The method of claim 16 further comprising:
attaching a plurality of fibers to the polyurethane foam via hot compression.

18. The method of claim 16 further comprising:
attaching a multilayer binder film that comprises a polar layer and a nonpolar layer to the polyurethane foam via hot compression.

19. The method of claim 16, wherein the composition has an absence of linear low density polyethylene.

20. The method of claim 16, wherein the composition has an absence of ethylene vinyl acetate copolymer.

21. The method of claim 16, wherein the composition further comprises ethylene vinyl acetate copolymer at 0.1 wt % to 10 wt %.

22. The method of claim 16, wherein the composition further comprises 0.1 wt % to 20 wt % of a stabilizer and/or an antioxidant.
